(19) United States
(12) Patent Application Publication
(10) Pub. No.: US 2026/0173061 A1
(43) Pub. Date: Jun. 18, 2026

(54) Enhanced Triggering Conditions for Rx Beam Pair Change Indication

(71) Applicant: Apple Inc., CUPERTINO, CA (US)

(72) Inventors: Jie CUI, San Jose, CA (US); Dawei ZHANG, Saratoga, CA (US); Manasa RAGHAVAN, Sunnyvale, CA (US); Qiming LI, Beijing (CN); Xiang CHEN, Campbell, CA (US); Yang TANG, San Jose, CA (US)

(21) Appl. No.: 18/836,542

(22) PCT Filed: Aug. 8, 2023
(86) PCT No.: PCT/CN2023/111802

§ 371 Date: Aug. 7, 2024

(51) Int. Cl. H04W 72/044

(52) U.S. Cl. CPC H04W 72/046

(57) ABSTRACT

A user equipment (UE) configured to decode, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair, determine an event related to the Rx beam pair has occurred and configure transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

### TECHNICAL FIELD

The present application relates to the field of wireless technologies and, in particular, to enhanced triggering conditions for Rx beam pair change indication.

### BACKGROUND

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

In some cases, multiple receive (multi-Rx) chain downlink (DL) reception at a UE may be beneficial. In some cases, such multi-Rx chain DL reception mechanisms may be used in Frequency Range 2(FR 2 ) (e.g., frequency bands from 24.25 GHz to 52.6 GHz and/or 52.6 GHz to 71 GHZ (or beyond) ). In such cases, it may be beneficial to introduce mechanisms for simultaneous DL reception from different directions with different quasi-colocation (QCL) TypeD reference signals (RSs) on a single component carrier (e.g., that may be used with enhanced FR2-1 UEs or other UEs).

In some instances, it may be beneficial to specify one

or more of: a layer 1(L 1 ) reference signal received power (RSRP) (L 1-RSRP) measurement delay; a layer 3(L3 ) measurement delay (e. g., cell detection delay and/or measurement period), where a starting point may be enhancement related to L1-RSRP measurement enhancements; radio link monitoring (RLM), bidirectional forward detection (BFD), and/or candidate beam detection (CBD) requirements; scheduling and/or measurement restrictions; transmission configuration indicator (TCI) state switching delay with dual TCI; and/or receive (Rx) timing difference between different directions (e.g., different QCL Type D RSs).

### SUMMARY

Some exemplary embodiments are related to an apparatus of a user equipment (UE), the apparatus having processing circuitry configured to decode, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair, determine an event related to the Rx beam pair has occurred and configure transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

Other exemplary embodiments are related to a processor configured to decode, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair, determine an event related to the Rx beam pair has occurred and configure transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

Still further exemplary embodiments are related to an apparatus of a base station, the apparatus having processing circuitry configured to configure transceiver circuitry to transmit configuration information related to simultaneous reception of signals from multiple transmission and reception points (TRPs) to a user equipment (UE), wherein the configuration information includes an identification that signals from a first TRP are received by the UE using a first reception (Rx) beam of a Rx beam pair and signals from a second TRP are received by the UE using a second Rx beam of the Rx beam pair, monitor for feedback signals from the UE related to the UE receiving the signals from the first TRP using the first Rx beam and signals from the second TRP using the second Rx beam and configure transceiver circuitry to transmit updated configuration information to the UE.

Additional exemplary embodiments are related to a processor configured to configure transceiver circuitry to transmit configuration information related to simultaneous reception of signals from multiple transmission and reception points (TRPs) to a user equipment (UE), wherein the configuration information includes an identification that signals from a first TRP are received by the UE using a first reception (Rx) beam of a Rx beam pair and signals from a second TRP are received by the UE using a second Rx beam of the Rx beam pair, monitor for feedback signals from the UE related to the UE receiving the signals from the first TRP using the first Rx beam and signals from the second TRP using the second Rx beam and configure transceiver circuitry to transmit updated configuration information to the UE.

### BRIEF DESCRIPTION OF THE DRAWINGS

To easily identify the discussion of any particular element or act, the most significant digit or digits in a reference number refer to the figure number in which that element is first introduced.

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 illustrates a diagram showing an exemplary UE according to embodiments herein.

FIG. 5 illustrates an exemplary situation where an exemplary UE can perform simultaneous reception from multiple transmission and reception points (TRPs) before rotation but cannot perform simultaneous reception after rotation of the exemplary UE, according to embodiments herein.

FIG. 6 shows an exemplary call flow where a UE is configured for event triggered reporting according to various exemplary embodiments.

FIG. 7 shows an exemplary call flow where a UE is configured for sensor based triggered reporting according to various exemplary embodiments.

FIG. 8 shows an exemplary call flow where a network reconfigures a UE based on feedback or a lack of feedback from the UE according to various exemplary embodiments.

FIG. 9 shows an exemplary call flow where a UE is configured to report a beam pair failure when no beam failure or link failure is identified for an individual beam at the UE according to various exemplary embodiments.

FIG. 10 shows an exemplary call flow where a UE 110 is configured for body proximity sensing (BPS) based measurement and reporting according to various exemplary embodiments.

### DETAILED DESCRIPTION

The exemplary embodiments may be further understood with reference to the following description and the related appended drawings, wherein like elements are provided with the same reference numerals. The exemplary embodiments relate to the initiating the beam pair update or indicating a beam pair issue for simultaneous reception of signals from multiple transmission and reception points (TRPs) related to user equipment (UE) movement (e.g., rotation). As used herein, simultaneous reception may refer to reception of signals at the same time or in a substantially contemporaneous manner.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network (e.g., 5G-advanced, 6g, etc.) and base station.

When a UE is performing simultaneous reception from multiple transmission and reception points (TRPs), there may be scenarios where the UE may no longer be able to perform the simultaneous reception from multiple TRPs, e.g., the UE rotates. When this happens, the UE will waste time for looking for a new beam pair and will also waste throughput before the next beam reporting interval (e.g., the reporting allowing the network to select a new beam pair) because the network is unaware that the beam pair is no longer valid at the UE.

The exemplary embodiments describe operations for a user equipment (UE) to perform enhanced triggering for beam pair change information (beam part updates) when simultaneous reception is being used. In the exemplary embodiments, the UE initiates the beam pair update and/or indicates to the network the beam pair issue as soon as possible.

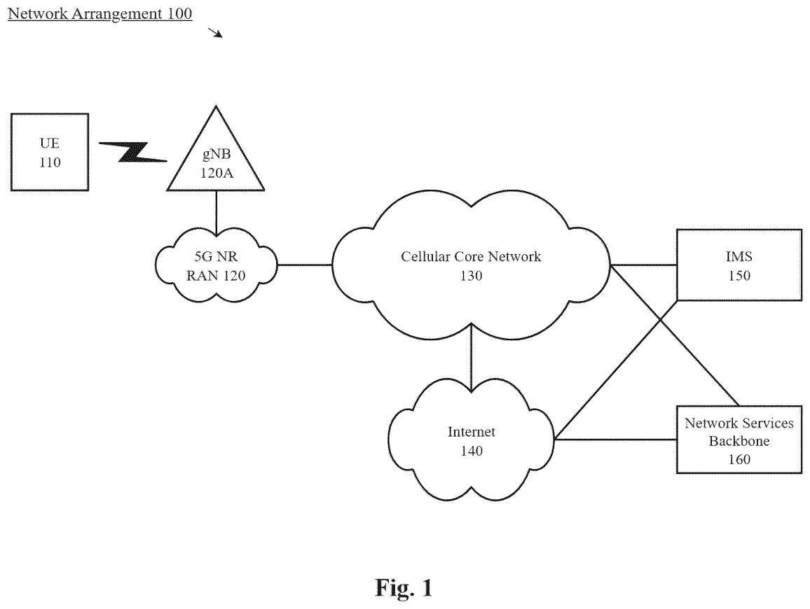

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e. g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc. ) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple transmission and reception points (TRPs). Throughout this description, a TRP generally refers to a set of components configured to transmit and/or receive a beam. TRPs. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

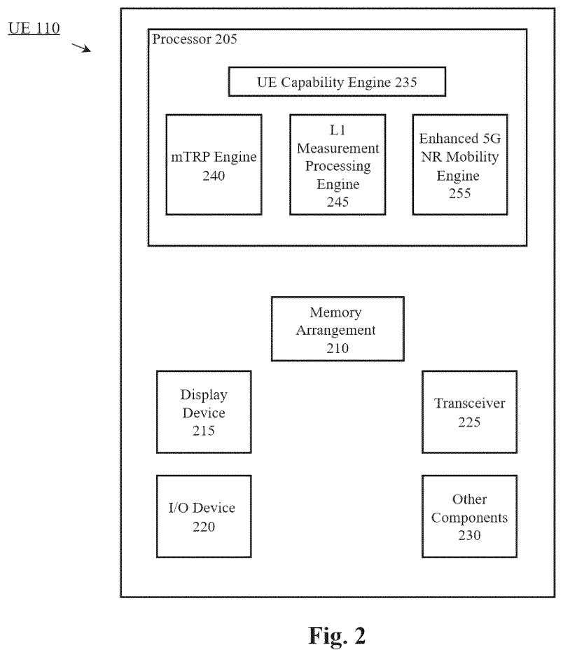

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a UE capability engine 235. The UE capability engine 235 may perform various operations related to the capabilities of the UE 110. To provide some general examples, the UE capability engine 235 may perform operations such as, but not limited to, determining the operating capabilities of the UE 110, determining when the capabilities of the UE 110 should change, informing the network of the capabilities of the UE 110, and the like.

The processor 205 may be configured to execute a plurality of engines of the UE 110. For example, the engines may also include a mTRP engine 240. The mTRP engine 240 may perform various operations related to mTRP operation. To provide some general examples, the mTRP engine 240 may perform operations such as, but not limited to, dynamically switching between mTRP mode and sTRP mode, updating a CC-group for mTRP operation and determining a default downlink beam/TCI-state for mTRP PDSCH reception.

The plurality of engines of the UE 110 may also include an L1 measurement reporting engine 245. The L1 measurement reporting engine 245 may perform operations including determining whether L1 measurements are colliding with L3 measurements. When such a collision is determined, some measurement results for RSs in a resource set may not be synchronized with measurement results for other RSs in the resource set. The L1 measurement reporting engine 245 may implement operations to, for example, omit certain measurement results from the measurement report or notify the network as to the whether some or all of the measurement results included in the measurement report are current or were determined in a previous measurement occasion.

The plurality of engines of the UE 110 may also include an enhanced 5G NR mobility engine 255. The enhanced 5G NR mobility engine 255 may perform various operations related to implementing the exemplary mobility framework described herein. These operations may include, but are not limited to, receiving configuration information, performing measurements, transmitting measurement reports, receiving DCI, receiving a MAC CE, etc.

The above referenced engines 235, 240, 245, and 255 each being an application (e.g., a program) executed by the processor 205 are merely provided for illustrative purposes. The functionality associated with each of the engines 235, 240, 245, and 255 may also be represented as a separate incorporated component of the UE 110 or may be a modular component coupled to the UE 110, e. g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

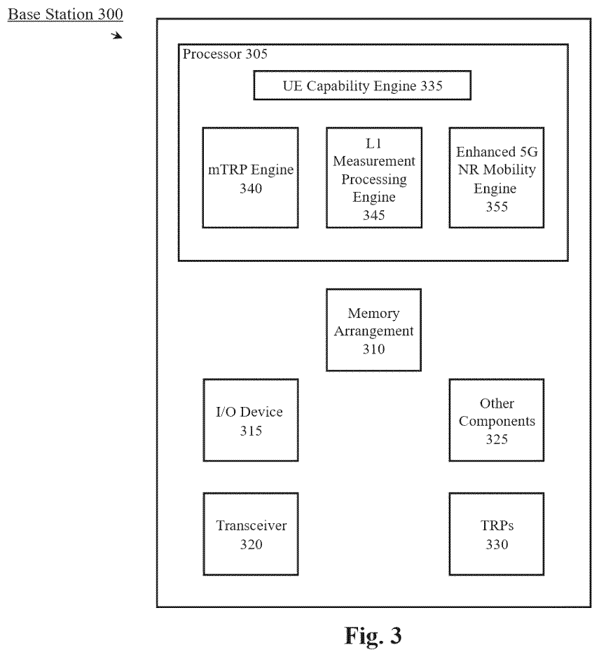

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, other components 325 and one or more transmission and reception points (TRPs) 330. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a UE capability engine 335. The UE capability engine 335 may perform various operations for the base station 300 related to the capabilities of the UE 110. To provide some general examples, the UE capability engine 335 may perform operations such as, but not limited to, transmitting a signal to inquire as to the capabilities of the UE 110, trigger the UE 110 to dynamically switch to a different set of capabilities, transmitting configuration information to the UE 110 to perform operations based on the current capabilities of the UE 110, and the like.

The processor 305 may be configured to execute a plurality of engines for the base station 300. For example, the engines may include a mTRP engine 340. The mTRP engine 340 may perform various operations related to mTRP operation. To provide some general examples, the mTRP engine 340 may perform operations such as, but not limited to, transmitting a signal to trigger the UE 110 to dynamically switch between mTRP mode and sTRP mode, transmitting information to update a CC-group for mTRP operation and indicating a default downlink beam/TCI-state for mTRP PDSCH reception.

The plurality of engines for the base station 300 may also include an L1 measurement processing engine 345. The L1 measurement reporting engine 345 may perform operations including receiving and processing measurement reports from a UE and performing beam management in reliance thereon.

The plurality of engines may include an enhanced 5G NR mobility engine 355. The enhanced 5G NR mobility engine 355 may perform various operations related to the exemplary mobility framework described herein. These operations may include, but are not limited to, transmitting a handover preparation request to another gNB, receiving capability information, transmitting configuration information, receiving measurement data, assigning resources, transmitting reference signals, transmitting DCI, transmitting a MAC CE, etc.

The above noted engines 335, 340, 345, and 355 each being an application (e.g., a program) executed by the processor 305 is only exemplary. The functionality associated with the engines 335, 340, 345, and 355 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e. g., a baseband processor, an applications processor, etc.). In particular, in some examples, it is the operations for communicating with the UE 110 that are typically handled by the baseband processor that may be reduced when the UE 110 is operating in the low battery mode. The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

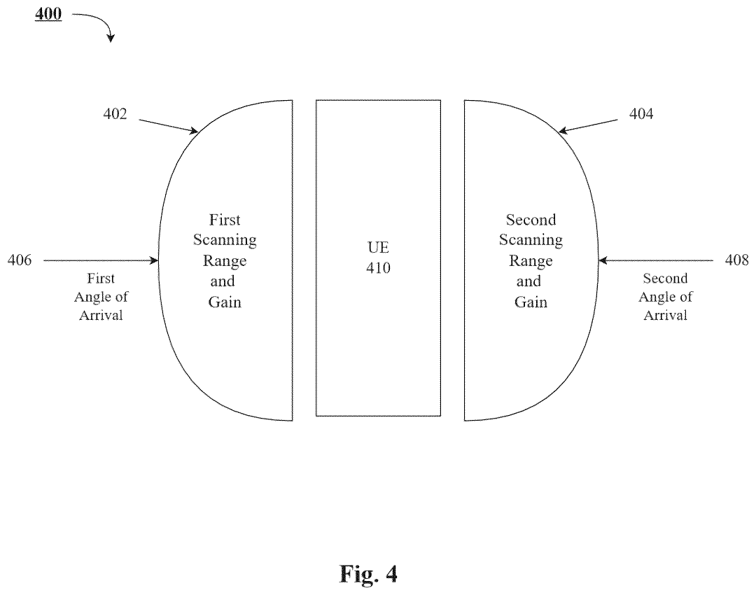

FIG. 4 Illustrates a diagram 400 showing a UE 410 according to example embodiments herein. The UE 410 may be capable of simultaneously receiving two beams used by the network using two antenna panels of the UE (with one antenna panel used for the receipt of a corresponding one of the two beams from the network). The diagram 400 illustrates a first scanning range and gain 402 of a first antenna panel of the UE 410 and a second scanning range and gain 404 of a second antenna panel of the UE 102 (which may be, for example, different than the first scanning range and gain 404) corresponding to this function. Under such circumstances, it may be understood that the first beam may arrive at the first antenna panel at a first angle of arrival 406 while the second beam may arrive at the second antenna panel at a second angle of arrival 408, as illustrated. Note that it is contemplated that, in some embodiments, this arrangement may be used to successfully receive multiple beams used by the network on the same component carrier (CC), while in other embodiments, the multiple beams may be of different CCs (e.g., carrier aggregation (CA) may be used).

In some cases, a first antenna panel and a second antenna panel are separate physical panels of the UE. However, it is noted that antenna panel as used herein may also be understood to refer to a logical antenna panel concept. Accordingly, it will be understood that the cases described herein of, e.g., first and second antenna panels, also encompasses cases where a single physical antenna panel module is used, where the first panel corresponds to a first weighting on that antenna panel module while the second panel corresponds to a second weighting on that antenna panel module.

Beam reporting mechanisms may allow for the UE to report, to a network, a pair of beams which the UE has the capability of using according to multiple receive (multi-Rx) chain downlink (DL) reception functionality.

Two example beam reporting mechanisms that may be used in wireless communications systems which allow a UE to support simultaneous reception of multiple beams (e.g., on the same CC or on different CCs) from different directions corresponding to different QCL TypeD RSs are described. A first such mechanism may use group-based beam reporting (GBBR), and it may be that a UE can report one pair of beams that it is capable of receiving simultaneously. In a second such mechanism, it may be that GBBR is used, and a UE may be able to report up to four pairs of beams.

It may be that in whatever case, for each of (one or more) beam pairs reported by the UE in a beam reporting message to the network, the UE may report L1-RSRP values for each beam in the pair. For example, if a beam pair including beams B1 and B2 is to be reported by the UE in a beam reporting message, the UE also reports the associated L1-RSRP for each of B1 and B2.

Herein, the L1-RSRP for each of, for example, B1 and B2 may be referred to respectively as RSRP_B1, RSRP_B2 according to convention used in this disclosure. Similar conventions may be followed herein with regard to other characteristics of a beam.

For example, an L1-SINR for each of B1 and B2 may be referred to respectively as SINR_B1, SINR_B2 according to convention used in this disclosure. As a further example, an angle of arrival (AoA) for each of B1 and B2 may be referred to respectively as AoA_B1 and AoA_B2.

In order to improve performance, the following aspects may be considered. Firstly, it has been identified that it is useful to define the use of one or more UE reporting criteria for beam pair reporting. That is, criteria for determining, at the UE, whether or not a beam pair has attributes such that it is desirable for use by the network for simultaneous DL communications to the UE (e.g., on the same CC or on different CCs), such that the UE elects to report the beam pair to the network may be established. A beam pair that is determined by the UE to have attributes according to such criteria making it desirable for, e.g., simultaneous DL communications to the UE may be referred to herein as a “qualified beam pair.”

Secondly, it has been identified that it is useful to establish a particular manner of updating a reported pair of beams. For example, in existing wireless communications systems, there may be no mechanism for determining whether a previously reported beam pair remains valid/useful at the UE, and/or how such information should be updated from/by the UE to the network as related circumstances change.

### Embodiments of Beam Pair Reporting Criteria

Embodiments related to the use of beam pair reporting criteria are now discussed. Such embodiments may relate to, for example, determinations at the UE regarding whether a first beam and a second beam receivable at the UE together constitute a qualified beam pair that should be reported to the network for (potential) use by the network for simultaneous communication with the UE. Herein, a first beam for such a consideration may be referred to as B1 and a second beam for such a consideration may be referred to as B2.

Consistent with description herein, one or more characteristics of each of B1 and B2 may be applied with one or more conditions in order to determine whether B1 and B2 represent a qualified beam pair. Examples of such characteristics that may be so used include, but are not limited to, RSRP (e.g., L1-RSRP) values for each of B1 and/or B2, AoA at the UE of each of B1 and/or B2, a signal to noise and interference ratio (SINR) of each of B1 and/or B2, etc.

In some cases of the use of such conditions, it may be that RSRP_B1 and RSRP_B2 are applied in relation to a relevant threshold value.

For example, a first condition may use an RSRP threshold value applicable to each of RSRP_B1 and RSRP_B2. The first condition may require that each of RSRP_B1 and RSRP_B2 is greater than or equal to (or greater than) the RSRP threshold value in order for B1 and B2 to be identified as a qualified beam pair. Accordingly, the UE may compare each of RSRP B1 and RSRP B2 to the RSRP threshold value and identify B1 and B2 as a qualified beam pair if each is greater than or equal to (or greater than) the RSRP threshold value.

As another example, a second condition may use an RSRP difference threshold value. The second condition may require that a difference between RSRP_B1 and RSRP_B2 is greater than or equal to (or greater than) the RSRP difference threshold value in order for B1 and B2 to be identified as a qualified beam pair. Accordingly, the UE may calculate a difference between RSRP_B1 and RSRP_B2, compare the difference to the RSRP difference threshold value, and identify B1 and B2 as a qualified beam pair if this difference is greater than or equal to (or greater than) the RSRP difference threshold value.

In some cases of the use of such conditions, it may be that AoA_B1 and an AoA_B2 are applied in relation to a relevant threshold value.

For example, a third condition may use an AoA offset threshold value. The third condition may require that an offset (e.g., an angular difference) between AoA_B1 and AoA_B2 is greater than or equal to (or greater than) the AoA offset threshold value in order for B1 and B2 to be identified as a qualified beam pair. Accordingly, the UE may calculate an offset between AoA_B1 and AoA_B2, compare this offset to the AoA offset threshold value, and identify B1 and B2 as a qualified beam pair if this offset is greater than or equal to (or greater than) the AoA offset threshold value.

In some cases of the use of such conditions, it may be that SINR_B1 and SINR_B2 are applied in relation to a relevant threshold value.

For example, a fourth condition may use an SINR threshold value applicable to each of SINR_B1 and SINR_B2. The fourth condition may require that each of SINR_B1 and SINR_B2 is greater than or equal to (or greater than) the SINR threshold value in order for B1 and B2 to be identified as a qualified beam pair. Accordingly, the UE may compare each of SINR_B1 and SINR_B2 to the SINR threshold value and identify B1 and B2 as a qualified beam pair if each is greater than or equal to (or greater than) the SINR threshold value.

As another example, a fifth condition may use an SINR difference threshold value. The fifth condition may require that a difference between SINR_B1 and SINR_B2 is greater than or equal to (or greater than) the SINR difference threshold value in order for B1 and B2 to be identified as a qualified beam pair. Accordingly, the UE may calculate a difference between SINR_B1 and SINR_B2, compare the difference to the SINR difference threshold value, and identify B1 and B2 as a qualified beam pair if this difference is greater than or equal to (or greater than) the SINR difference threshold value.

It is noted that the particular examples of conditions discussed herein are given by way of example and not by way of limitation.

Further, it is contemplated that in some embodiments, multiple conditions may be used when evaluating whether a pair of beams B1 and B2 are a qualified beam pair. For example, two (or more) of the conditions described herein may need to be satisfied in the manner described prior to the UE identifying that B1 and B2 are a qualified beam pair.

Note also that it has been recognized that in some cases, a beam reporting message identifying a qualified beam pair B1 and B2 may include more than, e.g., RSRP_B1 and RSRP_B2. For example, it may be in some cases that an SINR_B1 and SINR_B2 are (e.g., also) reported in the beam reporting message that identifies B1 and B2 as a qualified pair. Note that the use of the SINR values in the beam reporting message in this manner may correspond to the use of one or more SINR-related conditions by the UE to identify B1 and B2 as a qualified beam pair, as described herein.

The potential sources for relevant threshold values corresponding to the conditions used is now discussed. In some cases, the threshold value used may be a single pre-defined value at the UE for the corresponding condition.

In other cases, the threshold value used may be one of a pre-defined range of values for the corresponding condition at the UE. In some such cases, the one of the pre-defined values for the condition that is used at the UE may be signaled by the network to the UE when group-based beam reporting is configured to a UE. In other such cases, the one of the pre-defined values for the condition that is used at the UE may be signaled by the UE to the network in a UE capability message as corresponding to a UE capability.

It is possible, in cases where more than two beams are tested by the UE, that the UE may identify multiple qualified beam pairs through the use of one or more conditions as described herein. In cases where there are multiple qualified beam pairs identified, the UE may report them together in a single beam reporting message. Prior to sending such a beam reporting message, it may be that the UE ranks the qualified beam pairs within the beam reporting message.

Mechanisms for ranking multiple qualified beam pairs are now discussed. In some cases, the UE may rank a set of qualified pairs each having beams B1 and B2 based on sum of their respective RSRP_B1 and RSRP_B2 values. In such a case, it may be that the qualified beam pair with the largest sum ranks first, the qualified beam pair with the second largest sum ranks second, and so forth. Note that a summation for these RSRP values can be perform in either the linear domain or the logarithmic domain.

In some cases, the UE may rank a set of qualified beam pairs each having beams B1 and B2 based on a minimum value between RSRP_B1 and RSRP_B2 for each beam pair (which may be denoted min (RSRP_B1, RSRP_B2) for the beam pair). In such a case, it may be that the qualified beam pair with the largest min (RSRP_B1, RSRP_B2) ranks first, the qualified beam pair with the second largest min (RSRP_B1, RSRP_B2) ranks second, and so forth.

In some cases, the UE may rank a set of qualified beam pairs each having beams B1 and B2 based on a maximum value between RSRP_B1 and RSRP_B2 for each beam pair (which may be denoted max (RSRP_B1, RSRP_B2) for the beam pair). In such a case, it may be that the qualified beam pair with the largest max (RSRP_B1, RSRP_B2) ranks first, the qualified beam pair with the second largest max (RSRP_B1, RSRP_B2) ranks second, and so forth.

In some cases, the UE may rank a set of qualified pairs each having beams B1 and B2 based on sum of their respective SINR_B1 and SINR_B2 values. In such a case, it may be that the qualified beam pair with the largest sum ranks first, the qualified beam pair with the second largest sum ranks second, and so forth.

In some cases, the UE may rank a set of qualified pairs each having beams B1 and B2 based on the sum of their corresponding effective channel capabilities, where the effective channel capability corresponding to each of B1 and B2 is calculated using SINR_B1 and SINR_B2 respectively. For example, the effective channel capability for B1 may be calculated as log (1+SINR_B1) and the effective channel capability for B2 may be calculated as log (1+SINR_B2). Once the sum of these two values is calculated for each qualified beam pair, the qualified beam pair with the largest such sum ranks first, the qualified beam pair with the second largest such sum ranks second, and so forth.

In some cases, the UE may rank a set of qualified beam pairs each having beams B1 and B2 based on a minimum value between SINR_B1 and SINR_B2 for each beam pair (which may be denoted min (SINR_B1, SINR_B2) for the beam pair). In such a case, it may be that the qualified beam pair with the largest min (SINR_B1, SINR_B2) ranks first, the qualified beam pair with the second largest min (SINR_B1, SINR_B2) ranks second, and so forth. Note that the largest min (SINR_B1, SINR_B2) may relate to the minimum data rate supported at each beam, so the ranking on this basis may assist the network in making quality of service (QOS)-related determinations.

In some cases, the UE may rank a set of qualified beam pairs each having beams B1 and B2 based on a maximum value between SINR_B1 and SINR_B2 for each beam pair (which may be denoted max (SINR_B1, SINR_B2) for the beam pair). In such a case, it may be that the qualified beam pair with the largest max (SINR_B1, SINR_B2) ranks first, the qualified beam pair with the second largest max (SINR_B1, SINR_B2) ranks second, and so forth.

It is noted that the particular examples of ranking mechanisms discussed herein are given by way of example and not by way of limitation.

It is contemplated that multiple ranking mechanisms could be applied by the UE corresponding to a multiple-order ranking. For example, it may be that a first order ranking uses a first ranking mechanism, and that a second order ranking (e.g., to break any ties occurring based on the first order ranking) may use a different ranking mechanism, etc.

In some embodiments, it may be that the network (e.g., a base station) can further configure/restrict the beam pairs that can be reported by the UE. This may be useful in cases where it is desired to incorporate the effects of an AoA and/or an angle of departure (AoD) corresponding to the beams into the analysis, and where it cannot be assumed that the UE is capable of independently generating this information based on its receipt of the beams (e. g., because the UE is only capable of using relatively wide Rx beams on its antenna panels).

Various options for network-side considerations regarding the validity of a beam pair are now discussed. In a first option, for a qualified beam pair reported by the UE, the network starts a beam pair validity timer corresponding to that qualified beam pair. When the timer expires, the network considers the beam pair no longer valid/usable. In some embodiments, the staring value for the beam pair validity timer is provided to the network by the UE in a beam reporting message that indicates the qualified beam pair.

The starting value for the beam pair validity timer may be pre-defined (e.g., per a specification for the wireless communication system). The pre-definition may be of a single starting value. Alternatively, the pre-definition may be of a range of such starting values.

In some cases, it may be that the network configures two active transmission configuration indicator (TCI) states to the UE, one corresponding to each beam of the reported beam pair. In such circumstances, it may be that if the network receives a hybrid automatic repeat request acknowledgement (HARQ-ACK) from the UE corresponding to each of the first TCI state and the second TCI state, the beam pair validity timer for that beam pair is reset.

In some embodiments, once the beam pair validity timer expires, the network may initiate another group-based beam reporting procedure with the UE (e.g., in order to establish a new qualified beam pair to use for communications with the UE).

In some embodiments, the UE may transmit an override message to the network to override a beam pair validity timer, if the UE determines the beam pair is (e. g., still) valid. The override message can be sent to the network via any of radio resource control (RRC) message, a medium access control control element (MAC-CE), and/or an uplink control information (UCI) in various embodiments. In response to the override message, the network may reset the beam pair validity timer (e. g., to the original value and/or to a value that is specified by the UE in the override message).

Second options for network-side considerations regarding the validity of a beam pair at the network may be as follows. When periodic/semi-periodic group based reporting is in use, it may be that correspondingly periodic/semi-periodic beam reporting messages are received from the UE at the network. In such cases, the network may understand that the most recently reported beam pair(s) overrides previously reported beam pair(s). Further, if a beam pair validity timer (e.g., as described herein) is also used in such cases, it may be reset upon receiving each periodic/semi-periodic beam reporting message.

In some cases, it may be that a UE initiates a beam pair update by sending the network a beam pair update message. The beam pair update message may indicate, for example, one or two replacement beams for one or two of the beams B1, B2 that constitute a current qualified beam pair as understood at the network. Upon receiving the beam pair update message, the network may replace the beams B1 and/or B2 with the corresponding replacement beam(s) from the beam pair update message.

In some such cases, the beam pair update message can be considered/transmitted by the UE as UCI. In a first such alternative, the beam pair update message may be treated as special channel state information (CSI) feedback from the UE to the network. Under this alternative, it may be that the beam pair update message has a same priority as existing CSI in use, for example, a same priority as for L1-RSRP CSI feedback or for L1-SINR CSI feedback.

In a second such alternative of a beam pair update message as UCI, the beam pair update message may be treated/transmitted as a new type of UCI (e.g., in addition to the existing UCI like scheduling request (SR)/HARQ-ACK/CSI/configured grant uplink control information (CG-UCI), etc., which may be used in the wireless communication system). Under this alternative, the beam pair update message may be encoded standalone, using polar code. Alternatively, the beam pair update message may be jointly encoded with other types of UCI using polar code.

In other case for beam pair update messages (e. g., other than a beam pair update message as UCI as just discussed), a beam pair update message may be transmitted in a MAC-CE. In such cases, if the UE already has an uplink (UL) grant for physical uplink control channel (PUSCH) transmission, UE can transmit the MAC-CE using the existing UL grant.

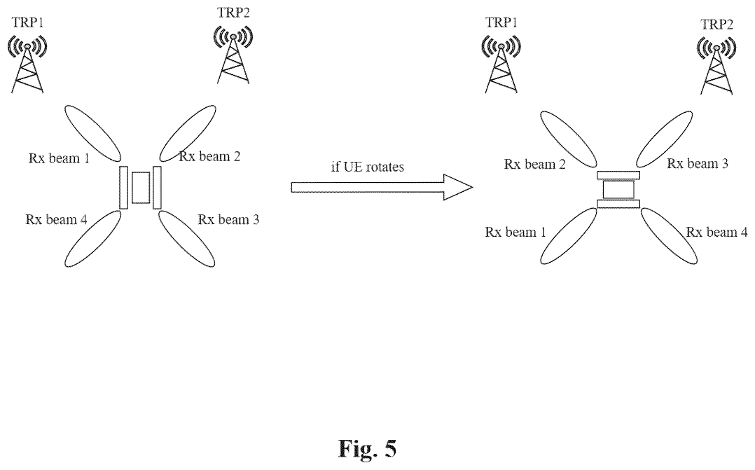

However, in some situations, the above discussed mechanism for the UE to indicate the beam pair update may have issues. For example, looking at FIG. 5, if the UE rotates, the UE may no longer be able to perform simultaneous reception from multiple TRPs. In FIG. 5, on the left side, a UE 110 is simultaneously receiving beams from both TRP1 and TRP2, e.g., the UE 110 is receiving RX beam 1 from TRP1 on panel 1 and is also receiving RX beam 2 from TRP2 on panel 2. In this manner, the UE 110 is capable of receiving simultaneous reception from TRP1 and TRP2 by receiving RX beam 1 and RX beam 2 on separate panels.

However, if the UE 110 rotates, as seen on the right side of FIG. 5, panel 1 of the UE 110 may no longer receive beams from TRP1 or TRP2 due to panel 1 being rotated away from TRP1 and TRP2. After rotation, the UE 110 cannot perform simultaneous reception from TRP1 and TRP2 by using RX beam 1 and RX beam 2 because the AoAs from the two TRPs result in both RX beams on the same panel. In this situation, panel 1 does not receive any beams. In this case, the UE 110 cannot perform a beam update if this rotation happens during periodic beam reporting, and a suitable beam pair may not be identified.

In a legacy case, where the UE has only one RX beam for reception, there is no problem caused by UE rotation. The UE will have a beam measurement procedure based on certain RS QCLed typeD with the active TCI for PDCCH/PDSCH reception, e.g., the UE will not be doing GBBR. Before and after UE rotation, the active TCI of PDCCH or PDSCH can always find a best RX beam according to the parallel beam measurement procedure, e.g., when a single beam measurement procedure is used, the UE rotation does not affect beam measurement. But for paired Rx beams, after UE rotation, even though UE has such beam measurement, the UE may be not able to find the new beam pair to support simultaneous receptions from TRP1 and TRP2, as shown in FIG. 5 above.

When a UE is doing group based beam reporting (GBBR), and a condition of the UE changes such that it cannot find a suitable beam pair (such as a rotation of the UE), the UE will waste time for looking for a new beam pair and will also waste throughput before the next GBBR measurement. The GBBR measurement is configured by the network, and therefore in between two GBBR reporting occasions, the network cannot know if the beam pair is valid or not at the UE side, and the network scheduling scheme cannot be changed in response to a beam pair change in a timely manner.

The example embodiments provide various manners of addressing this issue. In general, the UE will initiate a beam pair update and/or will indicate to the network the issue with trying to find a suitable beam pair at the receiver side as soon as possible. There are several examples that may be used by the UE to initiate and/or indicate the change in configuration. These example embodiments will be described in greater detail below.

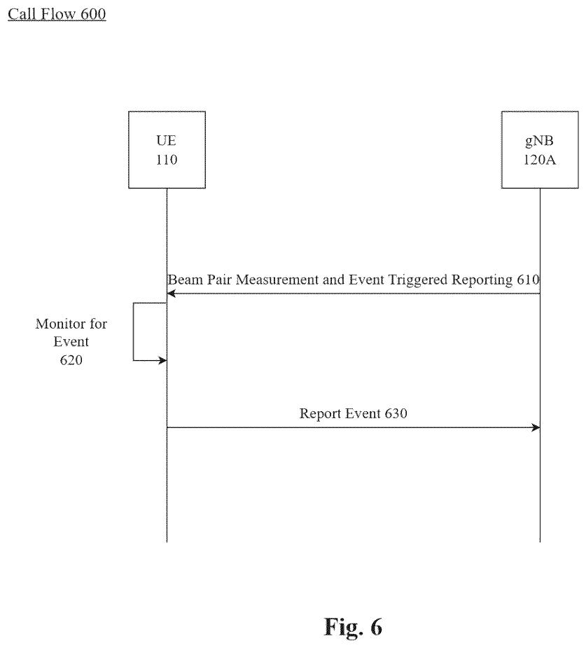

In a first example embodiment, event triggered reporting is configured by the network for the UE to report the issue to the network in a timely manner. The first example embodiment will be described with reference to the call flow of FIG. 6.

FIG. 6 shows an exemplary call flow 600 where a UE 110 is configured for event triggered reporting according to various exemplary embodiments. In the example of FIG. 6, the call flow 600 is performed between the UE 110 and the network (e.g., the gNB 120A).

In 610, the network (e.g., gNB 120A) configures the UE 110 with periodic RSs for beam pair measurement and event triggered reporting. In the example of FIG. 6, the beam pair measurement and event triggered reporting configuration is shown as being sent in the same message. However, this is only an example and multiple messages may be used.

The network may configure various events for the event triggered reporting. In one option, the event may be the Rx beam pair is not valid. A first example of the UE 110 determining that the event has occurred may be that the UE 110 cannot find a reliable Rx beam pair to support simultaneous reception of the Physical Downlink Control Channel (PDCCH) and/or the Physical Downlink Shared Channel (PDSCH) from the multiple TRPs. A second example of the UE 110 determining that the event has occurred may be that the Signal to Interference Noise Ratio (SINR) and/or the Reference Signal Received Power (RSRP) of any Rx beam is below a threshold. In a third example, a combined SINR/RSRP of an Rx beam pair is below a threshold, where the combined means is summation, or capacity based efficient SINR/RSRP pair, or smallest SINR/RSRP in the Rx beam pair.

In a second option, the event may be a beam failure or radio link failure that is identified by the UE 110 on any beam in the beam pair. In a third option, the event may be where the SINR or RSRP variation of any beam in the beam pair is larger than a threshold. These events are only examples and other events may also be configured by the network.

Thus, in 620, the UE 110 will monitor for the configured event. It should be understood that the UE 110 will also perform the configured beam pair measurements. In the example of FIG. 6, it may be considered that the UE 110 determines that the configured event has occurred.

In 630, the UE 110 will report to the network that the event has occurred. The UE 110 may report the event has occurred using L1 reporting (e.g., Uplink Control Information (UCI) ), MAC-CE reporting, RRC reporting, or perform a random access channel (RACH) procedure on the failed link (if one link has beam failure or link failure). The reporting may indicate that the Tx beam pair is not valid, the Rx beam pair is not valid, and/or a new GBBR resource set(s) is needed for measurement.

Thus, the first example provides manners for the UE 110 to timely report that the Rx beam pair is not valid based on the RS measurements performed by the UE 110.

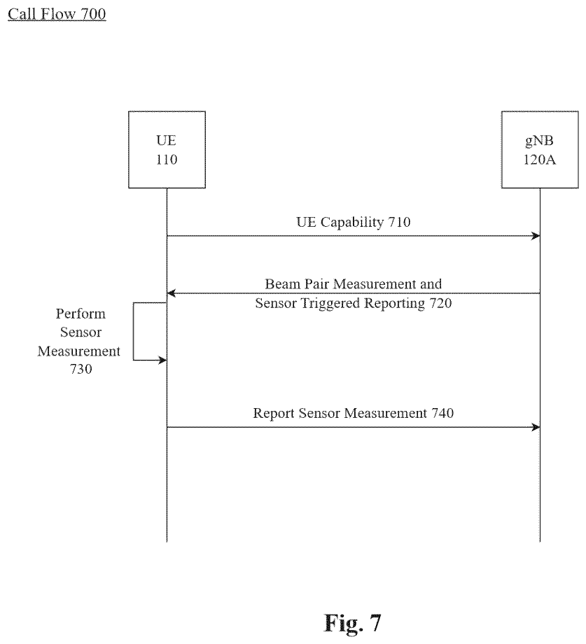

In a second example embodiment, sensor based triggering is configured by the network for the UE to report the issue to the network in a timely manner. The second example embodiment will be described with reference to the call flow of FIG. 7.

FIG. 7 shows an exemplary call flow 700 where a UE 110 is configured for sensor based triggered reporting according to various exemplary embodiments. In the example of FIG. 7, the call flow 700 is performed between the UE 110 and the network (e.g., the gNB 120A).

In 710, the UE 110 may indicate the capability of using a sensor to detect the rotation or beam change to the network. As will be described in greater detail below, the capability of the UE 110 to detect the rotation or beam change may be based on, for example, a gyroscope based UE posture or an accelerometer.

In 720, the network (e.g., gNB 120A) configures the UE 110 with periodic RSs for beam pair measurement and sensor based triggered reporting based on the UE 110 reporting the capability in 710. In the example of FIG. 7, the beam pair measurement and event triggered reporting configuration is shown as being sent in the same message. However, this is only an example and multiple messages may be used.

The network may configure various sensor measurements for the sensor triggered reporting based on the capabilities of the UE 110. In a first option, the sensor measurements may be gyroscope measurements that indicate a posture change of the UE 110 is above a threshold. In a second option, the sensor measurements may be accelerometer measurements that indicate a UE position change is above a threshold. These measurements are only examples and other measurements may also be configured by the network.

Thus, in 730, the UE 110 will perform the sensor measurements and monitor for the measurements to indicate rotation or beam change has occurred. It should be understood that the UE 110 will also perform the configured beam pair measurements. In the example of FIG. 7, it may be considered that the UE 110 determines, based on the sensor measurements, that the rotation or beam change has occurred.

In 740, the UE 110 will report to the network that the rotation or beam change has occurred. This reporting may be the actual sensor measurements or that an event indicated by the sensor measurements has occurred (e.g., rotation or beam change). The UE 110 may report the event (or sensor measurements) using L1 reporting (e.g., Uplink Control Information (UCI) ), MAC-CE reporting, RRC reporting, or perform a random access channel (RACH) procedure on the failed link (if one link has beam failure or link failure). The reporting may also indicate that the Tx beam pair is not valid, the Rx beam pair is not valid, and/or a new GBBR resource set(s) is needed for measurement.

Thus, the second example provides manners for the UE 110 to timely report that the Rx beam pair is not valid based on the sensor measurements performed by the UE 110.

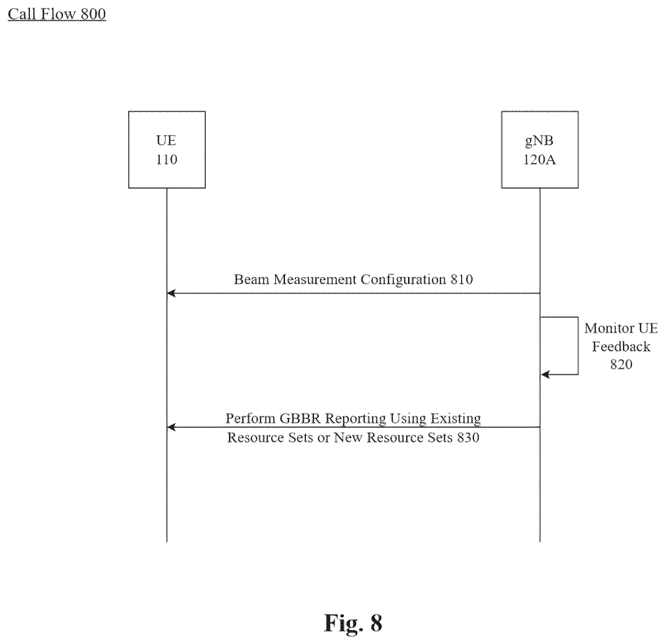

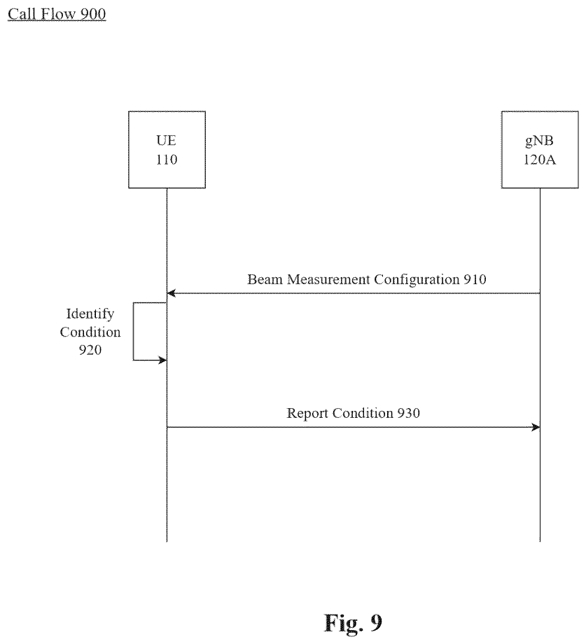

In a third example, beam pairs for simultaneous PDCCH/PDSCH reception from the TRPs may have a high block error rate (BLER), decoding error or reception failure but the individual BFD and RLM on these links with the TRPs are still good (e.g., no individual beam failure or link failure). This may occur because the Rx beam pair for simultaneous PDCCH/PDSCH reception from TRPs can be the different beams from individual best beam towards TRPs, e.g., to support simultaneous PDCCH/PDSCH reception from TRPs, Rx beam 1 and Rx beam 2 are used since they have the smallest interference. However, the individual Rx beam to only receive PDCCH/PDSCH from one TRP may be different from Rx beam 1 or 2. When this scenario occurs, the third example may include a network side based solution or a UE side based solution. The network side solution will be described with reference to FIG. 8 and the UE side based solution will be described with reference to FIG. 9.

FIG. 8 shows an exemplary call flow 800 where a network reconfigures a UE 110 based on feedback or a lack of feedback from the UE 110 according to various exemplary embodiments. In the example of FIG. 8, the call flow 800 is performed between the UE 110 and the network (e.g., the gNB 120A).

In 810, the network (e.g., gNB 120A) configures the UE 110 with periodic RSs for beam pair measurement.

In 820, the network monitors feedback from the UE 110. For example, the network may receive continuous negative acknowledgements (NACKs) or no acknowledgement (ACK) feedback from the UE 110 on one or two links (based on the corresponding beam) when network has scheduled simultaneous PDCCH/PDSCH to UE. However, the network has not received a beam failure or link failure report/indication from the UE 110.

When this occurs, in 830, the network may configure the UE 110 to perform GBBR reporting or configure new resource sets for UE 110 to measure and perform GBBR reporting.

FIG. 9 shows an exemplary call flow 900 where a UE 110 is configured to report a beam pair failure when no beam failure or link failure is identified for an individual beam at the UE 110 according to various exemplary embodiments. In the example of FIG. 9, the call flow 900 is performed between the UE 110 and the network (e.g., the gNB 120A).

In 910, the network (e.g., gNB 120A) configures the UE 110 with periodic RSs for beam pair measurement.

In 920, the UE 110 identifies a condition based on the configured measurements. As described above, the condition may be that the UE has a high BLER, decoding error or reception failure on one or two links (based on the corresponding beam) when the network schedules simultaneous PDCCH/PDSCH to the UE 110, but no beam failure or link failure is identified at UE 110.

In 930, the UE 110 will report to the network that the condition has occurred. The UE 110 may report the condition has occurred using L1 reporting (e.g., Uplink Control Information (UCI) ), MAC-CE reporting, RRC reporting, or perform a random access channel (RACH) procedure on the failed link (if one link has beam failure or link failure). The reporting may indicate that the Tx beam pair is not valid, the Rx beam pair is not valid, and/or a new GBBR resource set(s) is needed for measurement.

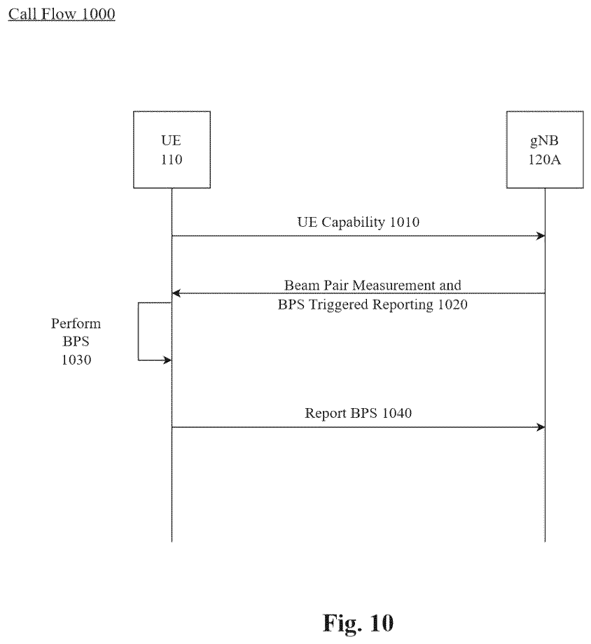

In a fourth example, which may also be capable of being used with one or more of the other examples, body proximity sensing (BPS) based measurement and reporting may be used. The second example embodiment will be described with reference to the call flow of FIG. 10.

FIG. 10 shows an exemplary call flow 1000 where a UE 110 is configured for body proximity sensing (BPS) based measurement and reporting according to various exemplary embodiments. In the example of FIG. 10, the call flow 1000 is performed between the UE 110 and the network (e.g., the gNB 120A).

In 1010, the UE 110 may indicate the capability of performing BPS to detect the rotation or beam change to the network. A BPS capability allows the UE 110 to determine whether a biological entity, biological presence (e.g., a human entity/presence) is located within a certain distance of the UE 110. This BPS capability may be used to detect the rotation or beam change for the UE 110.

In 1020, the network (e.g., gNB 120A) configures the UE 110 with periodic RSs for beam pair measurement and BPS based triggered reporting based on the UE 110 reporting the capability in 1010. In the example of FIG. 10, the beam pair measurement and BPS triggered reporting configuration is shown as being sent in the same message. However, this is only an example and multiple messages may be used.

In 1030, the UE 110 will perform the BPS measurements to determine if rotation or beam change has occurred. It should be understood that the UE 110 will also perform the configured beam pair measurements. In the example of FIG. 10, it may be considered that the UE 110 determines, based on the BPS measurements, that the rotation or beam change has occurred.

In 1040, the UE 110 will report to the network that the rotation or beam change has occurred. This reporting may be the actual BPS measurements or that an event indicated by the BPS measurements has occurred (e.g., rotation or beam change). The UE 110 may report the event (or sensor measurements) using L1 reporting (e.g., Uplink Control Information (UCI) ), MAC-CE reporting, RRC reporting, or perform a random access channel (RACH) procedure on the failed link (if one link has beam failure or link failure). The reporting may also indicate that the Tx beam pair is not valid, the Rx beam pair is not valid, and/or a new GBBR resource set(s) is needed for measurement.

### Examples

In a first example, a method is performed by a user equipment (UE), the method comprising decoding, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair, determining an event related to the Rx beam pair has occurred and configuring transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

In a second example, the method of the first example, wherein the indication is transmitted using uplink control information (UCI) signaling, medium access control control element (MAC-CE) signaling or radio resource control (RRC) signaling.

In a third example, the method of the first example, wherein the configuration information comprises periodic reference signals (RSs) for measurement of the Rx beam pair and the event is related to measurements performed by the UE on the periodic RSs.

In a fourth example, the method of the third example, wherein the event comprises the Rx beam pair is not valid based on (i) the UE being unable to find the Rx beam pair to support simultaneous reception of a Physical Downlink Control Channel (PDCCH) or a Physical Downlink Shared Channel (PDSCH) from the first TRP and the second TRP, (ii) a Signal to Interference Noise Ratio (SINR) for the first Rx beam or the second Rx beam is below a threshold, (iii) a Reference Signal Received Power (RSRP) for the first Rx beam or the second Rx beam is below a threshold, (iv) a combined SINR for the first Rx beam and the second Rx beam is below a threshold, or (v) a combined RSRP for the first Rx beam and the second Rx beam is below a threshold.

In a fifth example, the method of the third example, wherein the event comprises a beam failure or a radio link failure for the first Rx beam or the second Rx beam.

In a sixth example, the method of the fifth example, wherein the indication comprises a random access channel (RACH) procedure transmission for the first Rx beam or the second Rx beam.

In a seventh example, the method of the third example, wherein the event comprises a variation of a Signal to Interference Noise Ratio (SINR) for the first Rx beam or the second Rx beam is above a threshold, or a variation of a Reference Signal Received Power (RSRP) for the first Rx beam or the second Rx beam is above a threshold.

In an eighth example, the method of the first example, wherein a sensor of the UE detects the event.

In a ninth example, the method of the eighth example, further comprising configuring transceiver circuitry to transmit a capability related to the sensor to the base station.

In a tenth example, the method of the eighth example, wherein the sensor is a gyroscope and the event is a posture change of the UE above a threshold.

In an eleventh example, the method of the eighth example, wherein the sensor is an accelerometer and the event is a position change of the UE above a threshold.

In a twelfth example, the method of the first example, wherein the event comprises a block error rate (BLER) above a threshold, a decoding error or a reception error for one of the first Rx beam or the second Rx beam without a beam failure or a link failure of the one of the first Rx beam or the second Rx beam.

In a thirteenth example, the method of the first example, further comprising one or more sensors configured to perform body proximity sensing (BPS), wherein the event is a detection of a body based on the BPS.

In a fourteenth example, the method of the thirteenth example, further comprising configuring transceiver circuitry to transmit a capability related to the BPS to the base station.

In a fifteenth example, a processor configured to perform any of the methods of the first through fourteenth examples.

In a sixteenth example, a user equipment (UE) comprising a transceiver configured to communicate with a network and a processor communicatively coupled to the transceiver and configured to perform any of the methods of the first through fourteenth examples.

In a seventeenth example, a method performed by a base station, comprising configuring transceiver circuitry to transmit configuration information related to simultaneous reception of signals from multiple transmission and reception points (TRPs) to a user equipment (UE), wherein the configuration information includes an identification that signals from a first TRP are received by the UE using a first reception (Rx) beam of a Rx beam pair and signals from a second TRP are received by the UE using a second Rx beam of the Rx beam pair, monitoring for feedback signals from the UE related to the UE receiving the signals from the first TRP using the first Rx beam and signals from the second TRP using the second Rx beam and configuring transceiver circuitry to transmit updated configuration information to the UE.

In an eighteenth example, the method of the seventeenth example, wherein the feedback signals comprise continuous negative acknowledgement (NACK) signals for the first Rx beam or the second Rx beam.

In a nineteenth example, the method of the seventeenth example, wherein, when the apparatus monitors for the feedback signals, the apparatus does not receive acknowledgement (ACK) signals for one of the first Rx beam or the second Rx beam and does not receive a beam failure or link failure indication for the one of the first Rx beam or the second Rx beam.

In a twentieth example, the method of the seventeenth example, wherein the updated configuration information comprises an instruction for the UE to perform group based beam report (GBBR) measurements and reporting using previously configured resource sets.

In a twenty first example, the method of the seventeenth example, wherein the updated configuration information comprises an instruction for the UE to perform group based beam report (GBBR) measurements and reporting using newly configured resource sets.

In a twenty second example, a processor configured to perform any of the methods of the seventeenth through twenty first examples.

In an twenty third example, a base station comprising a transceiver configured to communicate with a user equipment (UE) and a processor communicatively coupled to the transceiver and configured to perform any of the methods of the seventeenth through twenty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e. g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAS.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
decode, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair;
determine an event related to the Rx beam pair has occurred; and
configure transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

2. The apparatus of claim 1, wherein the indication is transmitted using uplink control information (UCI) signaling, medium access control control element (MAC-CE) signaling or radio resource control (RRC) signaling.

3. The apparatus of claim 1, wherein the configuration information comprises periodic reference signals (RSs) for measurement of the Rx beam pair and the event is related to measurements performed by the UE on the periodic RSs.

4. The apparatus of claim 3, wherein the event comprises the Rx beam pair is not valid based on (i) the UE being unable to find the Rx beam pair to support simultaneous reception of a Physical Downlink Control Channel (PDCCH) or a Physical Downlink Shared Channel (PDSCH) from the first TRP and the second TRP, (ii) a Signal to Interference Noise Ratio (SINR) for the first Rx beam or the second Rx beam is below a threshold, (iii) a Reference Signal Received Power (RSRP) for the first Rx beam or the second Rx beam is below a threshold, (iv) a combined SINR for the first Rx beam and the second Rx beam is below a threshold, or (v) a combined RSRP for the first Rx beam and the second Rx beam is below a threshold.

5. The apparatus of claim 3, wherein the event comprises a beam failure or a radio link failure for the first Rx beam or the second Rx beam.

6. The apparatus of claim 5, wherein the indication comprises a random access channel (RACH) procedure transmission for the first Rx beam or the second Rx beam.

7. The apparatus of claim 3, wherein the event comprises a variation of a Signal to Interference Noise Ratio (SINR) for the first Rx beam or the second Rx beam is above a threshold, or a variation of a Reference Signal Received Power (RSRP) for the first Rx beam or the second Rx beam is above a threshold.

8. The apparatus of claim 1, further comprising a sensor configured to detect the event.

9. The apparatus of claim 8, wherein the processing circuitry is further configured to:
configure transceiver circuitry to transmit a capability related to the sensor to the base station.

10. The apparatus of claim 8, wherein the sensor is a gyroscope and the event is a posture change of the UE above a threshold.

11. The apparatus of claim 8, wherein the sensor is an accelerometer and the event is a position change of the UE above a threshold.

12. The apparatus of claim 1, wherein the event comprises a block error rate (BLER) above a threshold, a decoding error or a reception error for one of the first Rx beam or the second Rx beam without a beam failure or a link failure of the one of the first Rx beam or the second Rx beam.

13. The apparatus of claim 1, further comprising one or more sensors configured to perform body proximity sensing (BPS), wherein the event is a detection of a body based on the BPS.

14. The apparatus of claim 13, wherein the processing circuitry is further configured to:
configure transceiver circuitry to transmit a capability related to the BPS to the base station.

15. A processor configured to:
decode, from signaling received from a base station, configuration information related to simultaneous reception of signals from multiple transmission and reception points (TRPs), wherein signals from a first TRP are received using a first reception (Rx) beam of a Rx beam pair and signals from a second TRP are received using a second Rx beam of the Rx beam pair;
determine an event related to the Rx beam pair has occurred; and
configure transceiver circuitry to transmit an indication of the event to the base station, wherein the indication comprises (i) an indication that a transmission (Tx) beam pair is not valid, (ii) an indication that the Rx beam pair is not valid or (iii) an indication that one or more resource sets group based beam report (GBBR) are to be configured for the UE.

16. An apparatus of a base station, the apparatus comprising processing circuitry configured to:
configure transceiver circuitry to transmit configuration information related to simultaneous reception of signals from multiple transmission and reception points (TRPs) to a user equipment (UE), wherein the configuration information includes an identification that signals from a first TRP are received by the UE using a first reception (Rx) beam of a Rx beam pair and signals from a second TRP are received by the UE using a second Rx beam of the Rx beam pair;
monitor for feedback signals from the UE related to the UE receiving the signals from the first TRP using the first Rx beam and signals from the second TRP using the second Rx beam; and
configure transceiver circuitry to transmit updated configuration information to the UE.

17. The apparatus of claim 16, wherein the feedback signals comprise continuous negative acknowledgement (NACK) signals for the first Rx beam or the second Rx beam.

18. The apparatus of claim 16, wherein, when the apparatus monitors for the feedback signals, the apparatus does not receive acknowledgement (ACK) signals for one of the first Rx beam or the second Rx beam and does not receive a beam failure or link failure indication for the one of the first Rx beam or the second Rx beam.

19. The apparatus of claim 16, wherein the updated configuration information comprises an instruction for the UE to perform group based beam report (GBBR) measurements and reporting using previously configured resource sets.

20. The apparatus of claim 16, wherein the updated configuration information comprises an instruction for the UE to perform group based beam report (GBBR) measurements and reporting using newly configured resource sets.
